(19) United States
(12) Patent Application Publication
(10) Pub. No.: US 2008/0225370 A1
(43) Pub. Date: Sep. 18, 2008

(54) Low-cost continuous phase sheet deformable mirror

(75) Inventor: Justin Dennis Mansell, Albuquerque, NM (US)

Correspondence Address: Active Optical Systems - Justin D. Mansell, Ste 150, 2021 Girard, Albuquerque, NM, 87106, US

(73) Assignee: Active Optical Systems, LLC, Albuquerque, NM (US)

(21) Appl. No.: 11/725,338

(22) Filed: Mar. 16, 2007

(51) Int. Cl. G02B 26/08

(52) U.S. Cl. 359/224

(57) ABSTRACT

This continuous phase sheet deformable mirror leverages advances in polymer manufacturing to create a low-cost alternative to the existing microelectromechanical system (MEMS) and bulk (piezoelectric and electrostrictive) deformable mirror technology. These novel mirrors can be used for any form of phase control including but not limited to piston control, beam steering, and higher order adaptive optics. The preferred mirror surface is a pellicle, but any thin polymer high optical quality surface will suffice. The thin polymer phase sheet can be combined with any actuator structure, like those produced by MEMS, to create a higher quality hybrid deformable mirror.

### REFERENCES CITED

### U.S. PATENT DOCUMENTS

| Patent Number | Date Issued | Inventor | U.S. Class |
|---|---|---|---|
| 6,108,121 | August, 2000 | Mansell et al. | 359/291 |
| Provisional - | Mar. 16, 2006 | Mansell et al. | |
| 112975, 60/78346 | | | |

### OTHER PUBLICATIONS

T. BIFANO et al. “Continuous-Membrane Surface-Micromachined Silicon Deformable Mirror”, Optical Engineering, Vol. 36, No. 5, p. 1354-60, May, 1997.

G. VDOVIN et al., “Flexible mirror micromachined in silicon”, Applied Optics, 34(16), pp. 2968-2972, 1995.

R. GROSSO et al., “The membrane mirror as an adaptive optical element”, J. Opt. Soc. Am., 67(3), pp. 399-406, 1977.

S. ERRICO et al., “Stretched Membrane with Electrostatic Curvature (SMEC) Mirrors: A new technology for large lightweight space telescopes”, SPIE Proc. 4849, pp. 356-64 (2002).

F. ZAMKOTSIAN et al., “Polymer-based microdeformable mirror for adaptive optics”, SPIE Proc. 5719, (2005).

G. S. BURLEY et al., “Membrane mirror and bias electronics”, Applied Optics, 37 (21), pp. 4649-55, 1998.

H. TAKAMI et al., “Membrane deformable mirror for SUBARU adaptive optics”, SPIE Proc. 2201-78, 762-7 (1994).

G. PERCIN et al. “Controlled ink-jet printing and deposition of organic polymers and solid-particles,” Applied Physics Letters, vol. 73, no. 16, pp. 2375-2377, 19 Oct. 1998.

J. D. MANSELL et al. “Progress Toward Compact Low-Cost Adaptive Optics Systems”, DEPS Fourth Directed Energy Modeling & Simulation Conference (Mar. 19, 2006). (presentation available at www.mza.com)

S. BONORA et al. “Push-pull membrane mirrors for adaptive optics”, Optics Express v. 14 n. 25, 11935-44 (Dec. 11, 2006)

### DESCRIPTION

1. Field of the Invention

This invention relates generally to the field of adaptive optics, and in particular to a polymer deformable mirror suitable for use in a wide range of adaptive optics applications.

2. Background of the Invention

Adaptive optics is a technique for controlling the spatial phase of light that has been under development for several decades. In a general adaptive optics system, light is reflected from a deformable mirror and a small fraction is split off to illuminate a sensor. The sensor provides feedback to a control computer that adjusts the deformable mirror to change some property of the beam of light. Astronomers have used adaptive optics systems to remove the distortions induced by the atmosphere and achieve higher quality images from large telescopes. Adaptive optics systems have been used on lasers to improve the beam quality and to shape the intensity profile.

There are many commercial applications of the technology, but the widespread implementation of adaptive optics has been hampered by their high cost. To date, the cost of the deformable mirror has been the largest component cost in a typical adaptive optics system.

The most widely used deformable mirrors to date are comprised of a set of actuators attached to a reflective plate on one side and to a stiff backplane on the other. The actuators are typically piezoelectric (typically lead zirconium titanate) or electrostrictive (typically lead magnesium niobate). This conventional deformable mirror design has been used for many years, but the mirrors are very costly because of all the hand assembly required in their fabrication.

Microelectromechanical system (MEMS) technology has produced a variety of different deformable mirror architectures. The first generation of these devices was formed by combining a metal-coated silicon nitride membrane with a set of electrostatic pads. The mirror surface is deformed by applying a potential difference between the membrane and the electrostatic pads. These deformable mirrors were described in “Flexible mirror micromachined in silicon” by Vdovin, G. et al., in Applied Optics, 34(16), pp. 2968-2972, 1995. Similar membranes-type deformable mirrors were fabricated with metal membranes by R. Grosso et al., in “The membrane mirror as an adaptive optical element”, J. Opt. Soc. Am., 67(3), pp. 399-406, 1977.

Another MEMS deformable mirror design was disclosed by Bifano et al. in “Continuous-Membrane Surface-Micromachined Silicon Deformable Mirror”, Optical Engineering, Vol. 36, No. 5, p. 1354-60, May, 1997. Bifano discloses a deformable mirror produced by surface micromachining three layers of polycrystalline silicon and two sacrificial layers of silicon dioxide which separate the layers of polysilicon. The top layer of polysilicon forms the mirror surface. The bottom layer of polysilicon is used to create an array of electrode pads. The middle layer of polysilicon is patterned into an array of fixed-end double cantilevers which act as second electrodes for deforming the mirror. After the polysilicon layers are patterned, the sacrificial oxide layers are removed by drilling holes in the mirror surface and etching the mirror with hydrofluoric acid.

To address some of the deficiencies in Bifano's deformable mirror design, Mansell introduced several new types of deformable mirror (U.S. Pat. No. 6,108,121). This mirror used a similar architecture, but, since it was created with bulk micromachining, it could be fabricated with a truly continuous front surface and high optical quality.

All of the MEMS deformable mirrors are conducive to mass fabrication, but they suffer from the fact that mass fabrication of the devices typically requires a large expensive fabrication facility. Thus, in low volume, the amortization of the cost of the facility increases the cost of the devices to make them comparable to the conventional bulk actuator deformable mirrors.

In recent years, small optical pellicles have been developed for a variety of applications including beam splitters and as protective coatings for microlithography. These pellicles, which are typically made from nitrocellulose have demonstrated high optical quality and the ability to be coated with high reflectivity coatings.

Large membrane mirrors have become of recent interest for large lightweight telescopes. Recently, Errico et al. demonstrated a large membrane mirror made from CP-1, a membrane material developed by SRS Technologies, that was deformed spatially with electrostatic forces in “Stretched Membrane with Electrostatic Curvature (SMEC) Mirrors: A new technology for large lightweight space telescopes”, SPIE Proc. 4849, pp. 356-64 (2002). This membrane demonstrated reasonable optical quality and was able to be shaped using electrostatic forces. The electrostatic deformation was implemented by placing discontinuous sections of electrostatic actuators behind the membrane near the edges. This implantation was adequate for large apertures, but was not compatible with mass fabrication and did not offer any control of the mirror surface near the center of the membrane.

Recently Zamkotsian et al. published a paper on a deformable mirror using polymer actuators in “Polymer-based microdeformable mirror for adaptive optics”, SPIE Proc. 5719, (2005). The advantages of this design are a reduced voltage, but they do so at the cost of high speed performance.

Takami et al. demonstrated a nitrocellulose membrane deformable mirror in “Membrane deformable mirror for SUBARU adaptive optics”, SPIE Proc. 2201-78, 762-7 (1994). Their deformable mirror operated at reduced atmospheric pressure, but this made the device complicated. Furthermore, their device used a very thick backplane made of Macor with a glass insulating layer. A disadvantage of with using a glass insulating layer is that over time the glass tends to accumulate charge and induce a permanent deformation of the mirror surface that cannot be controlled. A very similar device was published by G. S. Burley et al. in “Membrane mirror and bias electronics”, Applied Optics v. 37 (21), pp. 4649-55 (1998).

### OBJECTS AND ADVANTAGES OF THE INVENTION

In recent years plastic has been used to create low-cost optics in many commercial products including low-cost cameras, barcode scanners, and the optical computer mouse. In light of the advances in polymer optics, an object of the present invention is to provide a high optical quality active mirror that is at least partially polymer to leverage the advances in polymer optics to create a mirror that is both low-cost and mass fabrication compatible. These active mirrors can be deformable mirrors, steering mirrors, focus mirrors, and/or piston mirrors.

It is a further object of the present invention to introduce a hybrid active mirror architecture comprising a polymer front surface and a wide variety of different types of actuators, including but not limited to MEMS actuators, electrostatic actuators, piezoelectric actuators, electrostrictive actuators, fluidic actuators, and thermal actuators. These and other objects and advantages of the invention will be apparent after considering the ensuing descriptions and accompanying drawings.

### SUMMARY OF THE INVENTION

The above objectives are obtained by combining a high quality polymer membrane with a second substrate of actuators. In the preferred embodiment, the polymer membrane is a polymer pellicle attached to a stiff frame. One method of fabricating the described framed membrane is to spin-cast a liquid polymer material to a polished substrate, allow it to cure into a solid thin film, remove it from the substrate and attach it loosely to a large frame, and then epoxy the membrane to a smaller frame with a controlled weight such that it is in tension on the smaller frame. After attaching it to the frame, the membrane can be coated on one surface with a high reflectivity coating and on the opposite surface with a conductive coating. Some types of polymer membranes bonded to frames are commercially available as optical pellicles. This membrane and frame are then bonded to an actuator array.

In the preferred embodiment, the mirror is actuated electrostatically by an electrostatic pad array fabricated using a printed circuit board below the membrane. The Japanese group used an expensive Macor substrate, but one object of this invention is to show that it can be accomplished much less expensively with lower-cost materials like printed circuit board. The membrane could also be actuated via an array of any type of actuator including but not limited to piezoelectric actuators, thermal actuators like bimetallic strips, fluidic pressure actuators, or magnetic actuators. Some of these actuators would have to be bonded to the mirror.

In another embodiment described here, the actuator array is micromachined actuator array comprising a pillar connecting the mirror membrane to a flexible interstitial layer and an electrostatic pad. The interstitial layer provides mechanical restoring force as the electrostatic pad beneath this interstitial layer attracts it. This is different from the prior Mansell work or the Zamkotsian work in that the mirror surface is formed separately and the mirror surface is a polymer.

In this invention, it is possible to include a section of the membrane that is stiffer than the surrounding area. This is desirable for applications that only want to induce tilt or piston phase shifts to a beam of light. The stiff section of the membrane can be created by a variety of processes including by bonding a stiff piece of material to the membrane, by introducing a second stiffer material into the membrane during the fabrication of the membrane, or by adjusting the membrane thickness by etching the membrane after it has been created with something like an oxygen plasma or casting the membrane into a shape during its curing process.

This invention also describes an alternative embodiment in which the frame is integrated with the actuators such that the polymer membrane can be bonded directly to the actuators without the need of a frame. One method of accomplishing this is to etch a recess into the actuator substrate for the actuators such that the original surface of the actuator substrate becomes the frame. Another fabrication method is to build up material on the surface of an actuator array through methods like electroplating or spin-casting and photolithography. Another fabrication method is to screen-print a material like epoxy onto an actuator array and curing it to create the frame.

### BRIEF SUMMARY OF THE FIGURES

FIG. 1 is a cross-sectional view of a polymer active mirror with electrostatic actuators.

FIG. 2 is a cross-sectional view of a polymer active mirror integrated with electrostatic actuators made using MEMS.

FIG. 3 is a cross-sectional view of the assembly of a polymer active mirror with electrostatic actuators made using MEMS in which the pillars are formed as part of the membrane and the bonding occurs between the tips of the pillars and the electrostatic MEMS actuators.

FIG. 4 is a cross-sectional view of the assembly of a polymer active mirror with electrostatic actuators made using MEMS in which the pillars are formed as part of the actuators and bonded onto the back of the mirror.

FIG. 5 is a cross-sectional view of the assembly of a polymer active mirror with electrostatic actuators in which the pillars, interstitial layer, and the supports to the interstitial layer are formed as part of the membrane and the bonding occurs between the tips of the supports and the second substrate.

FIG. 6 is a cross-sectional view of the assembly of a polymer active mirror with electrostatic actuators in which the pillars and the interstitial layer are formed as part of the membrane, the supports for the interstitial layer are part of the underlying substrate, and the contact occurs between the tips of the supports and the interstitial layer.

FIG. 7 is a cross-sectional view of the assembly of a polymer active mirror with electrostatic actuators in which the pillars and a segmented interstitial layer are formed as part of the membrane, the supports for the interstitial layer are part of the underlying substrate, and the contact occurs between the tips of the supports and the interstitial layer.

FIG. 8 is a cross-sectional view of the assembly of a polymer active mirror with electrostatic actuators in which the pillars and the segmented interstitial layer are formed as part of the membrane, the supports for the interstitial layer are formed by etching recesses into the second substrate, and in the final assembly contact is made between the tips of the supports and the interstitial layer.

FIG. 9 is a cross-sectional view of a high reflectivity active mirror made by bonding a polymer membrane with a high reflectivity coating and its frame to a second substrate with electrostatic actuators.

FIG. 10 is a cross-sectional view of a polymer active mirror with a section of different material bonded to the membrane to provide increased stiffness.

FIG. 11 is a cross-sectional view of a polymer active mirror with a mirror membrane bonded directly to a substrate with recessed electrodes.

FIG. 12 shows a three-dimensional rendering of the mirror shown in cross-section in FIG. 1.

### DETAILED DESCRIPTION

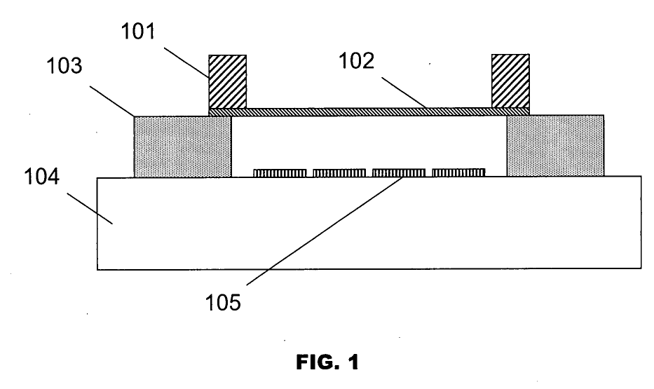

FIG. 1 illustrates a first embodiment of the invention. In this embodiment, shown in cross-section, a polymer membrane 102 attached to a frame 101 is bonded to a second substrate with actuators. The second substrate 104 is coated with patterned electrostatic actuator pads 105. Then the second substrate has a spacer 103 applied to it such that the distance between electrostatic actuators 105 and the membrane 102 can be controlled. The membrane 102 and frame 101 are bonded to the spacer 103 on the second substrate to create the mirror.

In the preferred embodiment the polymer membrane 102 is either conductive itself or coated with a thin layer of conductive material to enable electrostatic attraction between the underlying pad arrays and the membrane. The polymer membrane 102 can be made conductive by incorporation of an additive during formation, like graphite or silver. If the polymer membrane is non-conductive, a thin layer of a conductor can be applied. Example conductors include, but are not limited to, metals like aluminum, silver, or gold, and conductive oxides like indium tin oxide.

The spacer 103 can be fabricated in a variety of ways. One way is to etch a recess into the second substrate before creating the electrostatic actuator pads. Other ways of creating the spacer 103 are to build-up material on the edges by patterned deposition through a mask like screen printing, controlled spatial deposition like is done with ink-jets (see G. Percin et al. “Controlled ink-jet printing and deposition of organic polymers and solid-particles,” Applied Physics Letters, vol. 73, no. 16, pp. 2375-2377, 19 Oct. 1998.), bulk deposition and photolithography, bulk deposition of a UV-cure material and patterned UV exposure, and application of a pre-patterned solid material spacer like a metal perform, a patterned thin film, piece of adhesive tape, or a precise glass bead. These methods are just examples and, as such, are not exhaustive. The preferred embodiment would use a paste of precision glass beads in an epoxy binder to achieve the spacer and the bonding process simultaneously.

In the embodiment in FIG. 1, the actuator patterns 105 can be created by a variety of methods. Some of these methods include but are not limited to using screen-printing technology, ink-jet technology, bulk deposition and photolithography, and bulk deposition and UV curing through a photo-mask. In this embodiment, the actuator patterns 105 can be any conductive material including but not limited to metals like aluminum, silver, or gold, or conductive oxides like indium tin oxide. The preferred embodiment uses aluminum pads patterned with bulk deposition and photolithography.

The second substrate 105 can be any material that can be machined to reasonable flatness. The preferred embodiment uses a silicon wafer, but cost of this substrate is forcing consideration of other materials, like FR4 printed circuit board material, ceramics, and injection molded polymer.

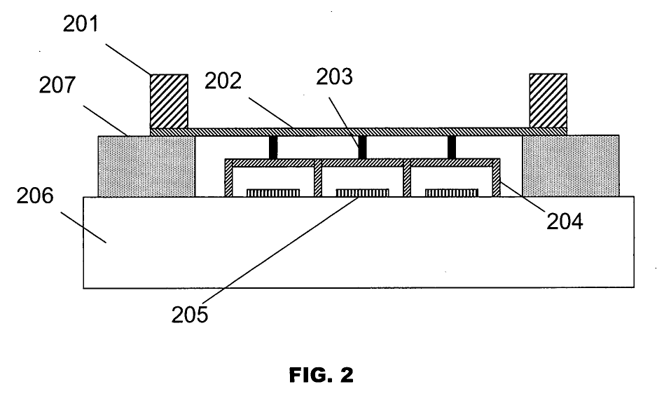

FIGS. 2-8 show different embodiments of a hybrid active mirror consisting of a polymer mirror surface and second substrate of another type of actuators that get attached to the polymer mirror surface. The assembled cross-sectional view in FIG. 2 shows a polymer mirror membrane 202 attached to pillars 203 which convey force from underlying actuators made of an interstitial layer with supporting material 204 and electrostatic pads 205. The electrostatic pads 205 and the supports for the interstitial layer 204 rest on a second substrate 206. The mirror 202 and frame 201 are bonded to the pillars 203 aon a spacer 207. The mirror actuation comes from the attraction of the interstitial layer 204 to the electrostatic pads 205. This mirror architecture is superior for some applications because the electrostatic attraction provides the ability to deflect the mirror toward the pillars while the mechanical strength of the interstitial layer provides a restoring force to localize the deflection.

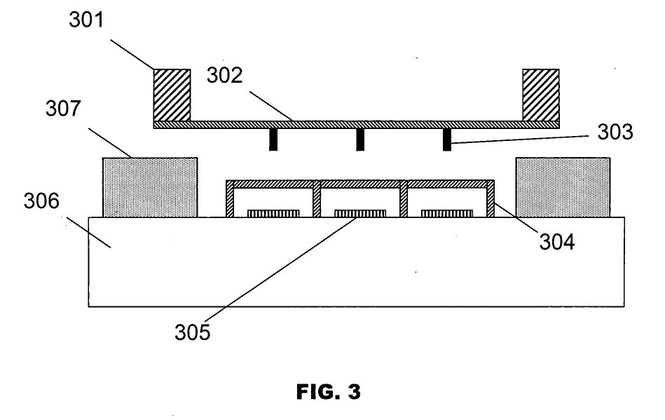

FIGS. 3-8 show different ways of fabricating the embodiment shown in FIG. 2. In FIG. 3, the pillars 303 are attached to the back of the mirror surface 302 before assembly. The pillars 303 would most probably be formed during the fabrication of the mirror 302 through a molding process. The pillars 303 can also be fabricated of a hardening bonding material like epoxy and applied by a precision pipette or ink-jet type application process. The pillars do not have to be any particular shape as they are primarily used to space the mirror surface from the underlying actuators. Then the mirror 302, frame 301, and pillars 303 are bonded to the interstitial layer 304. The frame 301 and edge of the mirror membrane 302 rest on a spacer 307, which is on a second substrate 306, to control the distance between the mirror 302 and the interstitial layer 304.

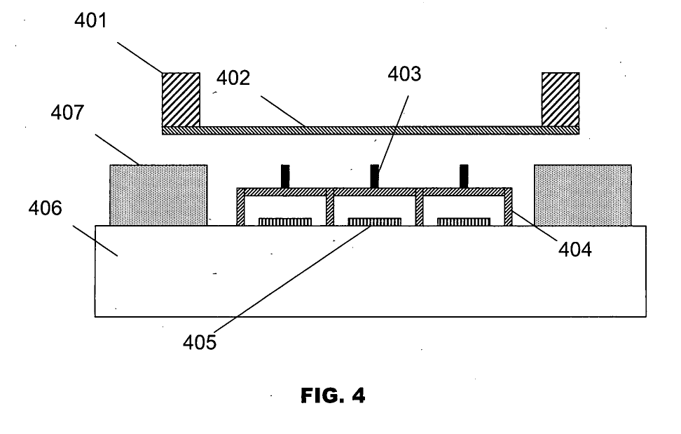

FIG. 4 shows an alternative fabrication method and an actuator variation of the design shown assembled in FIG. 2. In FIG. 4, the pillars 403 are created attached to the interstitial layer 404. The tips of the pillars 403 are bonded to a mirror membrane 402 that is mounted into a frame 401. A precision spacer 407 is used to control the separation between the mirror membrane 402 and the actuators. In this embodiment, the actuators do not have electrostatic pads because the actuation is provided by making the interstitial layer 404 of two materials with dissimilar expansion in an electric field or dissimilar thermal expansion. One such pair of materials is lead zirconium titanate (PZT), which is a piezoelectric material, and silicon. The interstitial layer 404 is attached to a second substrate 405 for structural strength.

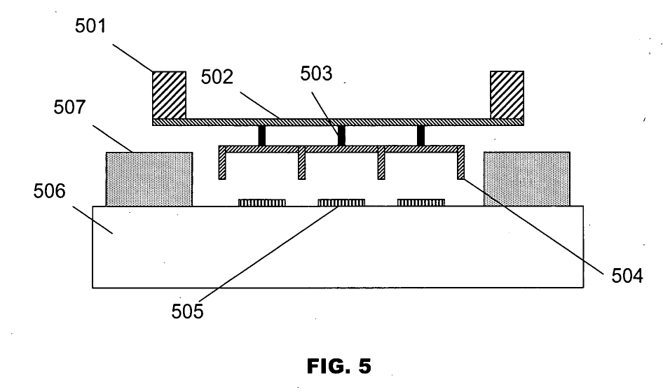

FIG. 5 shows another variation of the fabrication of the embodiment shown in FIG. 2. The pillars 503 and the interstitial layer and its supports 504 are fabricated attached to the mirror 502, which is mounted in a frame 501. Fabrication like this can be accomplished through processes like injection molding or bonding. The second substrate 506 is fabricated with electrostatic pads 505 and a spacer 507. The frame 501 and mirror 502 are bonded to the spacer 507 to create the mirror. Fabrication using a molding method is advantageous because it eliminates the necessity of bonding each actuator and instead the mirror can be fabricated with one bond step that bonds the frame 501 to the spacer 507.

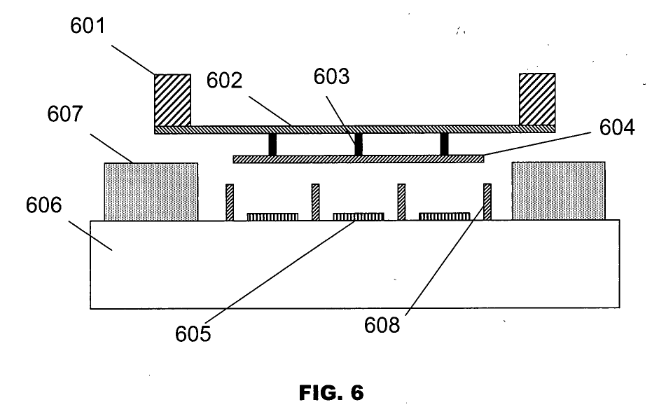

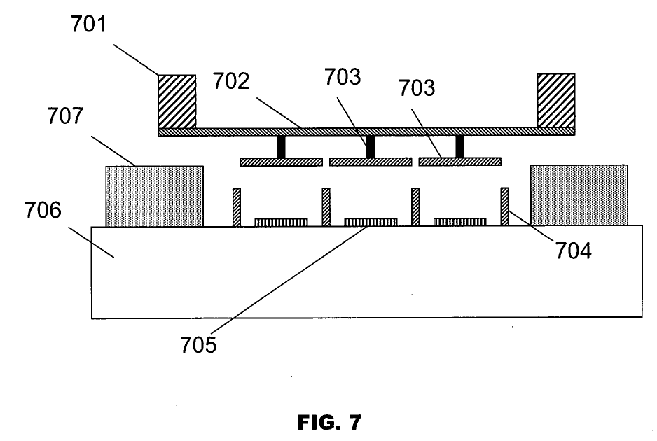

FIG. 6 shows another embodiment of the architecture shown in FIG. 2 in which the mirror 602 is fabricated with the pillars 603 and the interstitial layer 604 already attached to the mirror 602. This fabrication can be accomplished with injection molding the entire part or by injection molding the pillars and the interstitial layer and then curing the liquid polymer that is the mirror with the tips of the pillars in the curing mirror to create a bond. Another fabrication of the top surface involves creating the entire mirror surface 602, pillars 603, and interstitial layer 604 as one piece via a process like molding. The mirror 602 is again in a frame 601 so that it can be held in tension. The frame 601 and mirror 602 are then bonded to a spacer 607 on a second substrate 606 such that the interstitial layer 604 rests on support pillars 608 after the bonding is complete. The support pillars 608 can be bonded to the interstitial layer 604, but it is not necessary for proper operation of the mechanical-electrostatic actuator pairs. FIG. 7 shows a variation on the embodiment shown in FIG. 6. The difference is that the interstitial layer 703 is segmented, which may allow for simplified fabrication.

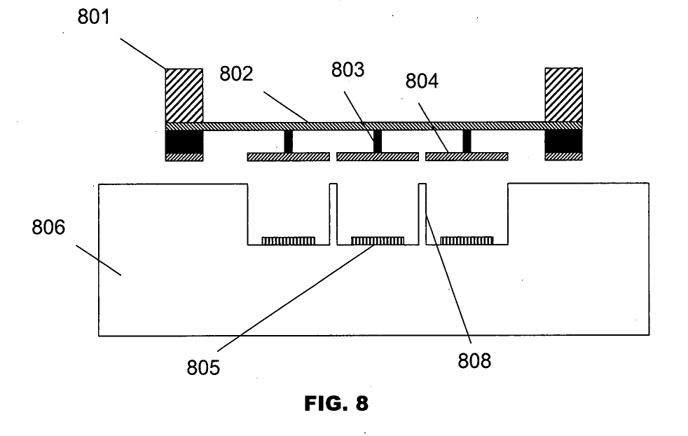

FIG. 8 shows another variation on the embodiment shown in FIG. 6. In this embodiment, the supports 808 for the interstitial layer 804, which is segmented like in FIG. 7, are formed by etching recesses into the second substrate 806. Recessed into the second substrate 806 are electrostatic pads 805 for attracting the interstitial layer 804. The interstitial layer 804 and pillars 803 are formed attached to the mirror 802. The mirror 802 is attached to a frame 801. The frame 801 and mirror 802 are bonded to the second substrate 806 in sections that are not recessed. Thus the recessing of the electrodes 805 creates a controlled space between the electrostatic pads 805 and the interstitial layer 803 after bonding. This is another embodiment in which the interstitial layer does not need to be bonded to the second substrate since just being in contact with the support pillars 808 is sufficient to obtain good mirror operation.

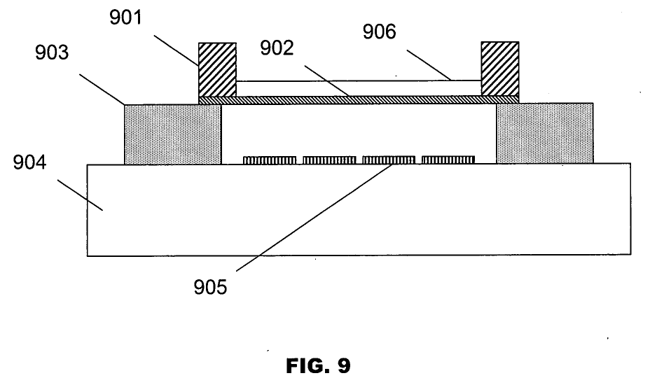

FIG. 9 shows a variation of the mirror in FIG. 1. It is again -fabricated by bonding a polymer membrane 902 mounted in a frame 901 to a second substrate 904 with a spacer 903, electrostatic actuator pads 905. The added part in this mirror is the use of a high reflectivity coating 906 on the mirror surface. Example high reflectivity coatings include, but are not limited to, metallic coatings, metallic coatings enhanced in reflectivity and protected from the environment by a thin layer of non-permeable dielectric, or multi-layer dielectric coatings.

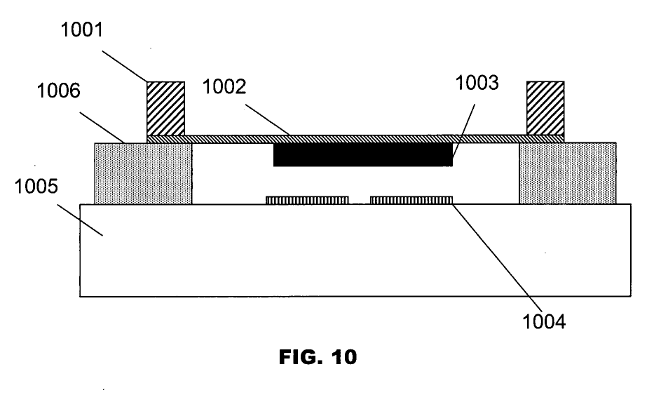

FIG. 10 shows another slight modification of the mirror in FIG. 1 in which a stiffer material 1003 is bonded to the mirror. In the embodiment shown in FIG. 10, this stiffer material 1003 is used to hold a portion of the mirror flat during operation so that no wavefront distortion higher than second order can affect the beam. To complete the assembly, the mirror 1002 and frame 1001 are bonded to a substrate 1005 with a spacer 1006 and electrostatic pad arrays 1004. This embodiment can be used to apply piston and tilt to the beam. Alternate embodiments might include having the stiff section 1003 be incorporated into the polymer membrane by adding a second stiffer material to the polymer during its formation. Some appropriate stiffening materials include, but are not limited to, fiber-glass and pieces of silicon. Sections of the membrane can also be made stiffer by changing the mirror thickness in different regions. Some possible methods of changing the mirror thickness include, but are not limited to, molding the mirror material during its fabrication or using photolithography and etching to pattern the material.

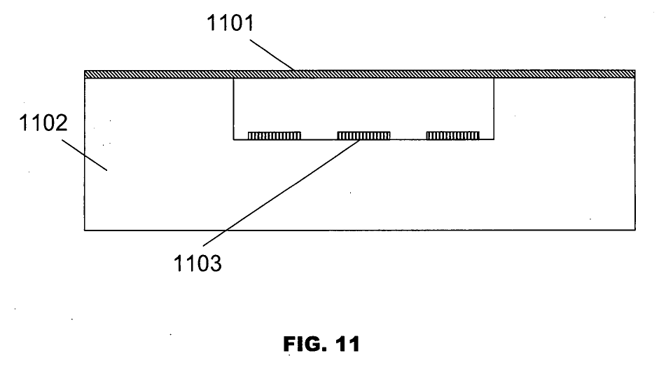

FIG. 11 shows a variation on the embodiment presented in FIG. 1 in which the frame for the polymer mirror membrane 1101 is integrated with the underlying substrate 1102. Fabrication of this embodiment would begin by creating recessed electrodes 1103 on a substrate 1102. Then the mirror 1101 would be bonded to the substrate 1102 using the portions that are not recessed as a frame. In this embodiment, the mirror membrane 1101 could be coated for reflectivity and conductivity either before or after the bonding. This method could also be used for creation of a hybrid mirror as well to eliminate the need for and additional frame.

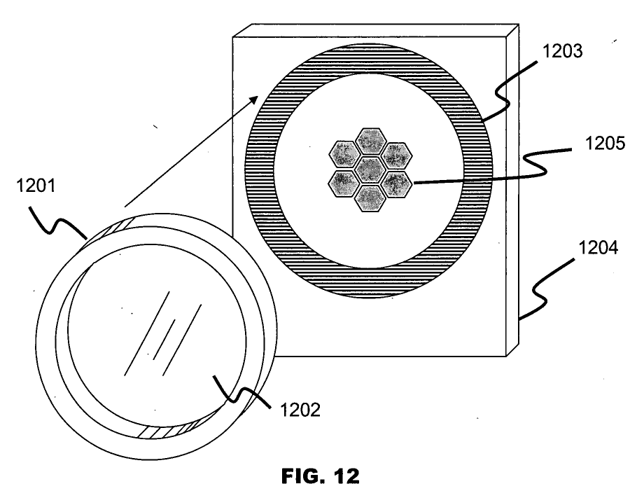

FIG. 12 shows a three-dimensional rendering of the mirror that is shown in cross-section in FIG. 1. The mirror 1202 and frame 1201 are shown disconnected from the substrate 1204. When assembled, the frame 1201 sits on the spacer 1203 such that there is a fixed distance between the mirror surface 1202 and the electrostatic pad arrays 1205.

What is claimed is:

1. An active mirror comprising:
a. a polymer membrane,
b. an optically reflective layer or layers either made a part of the membrane or applied to either surface of the membrane,
c. a conductive layer or layers either made a part of the membrane or applied to either surface of the membrane, and
d. a second continuous substrate attached to the membrane having at least one actuator that is not ceramic.

2. The active mirror of claim 1 where the second continuous substrate is made of silicon, glass, a polymer, or unpolished printed circuit board material like FR4.

3. The active mirror of claim 2 where the polymer membrane is stretched over a frame and the frame is bonded to a second substrate.

4. The active mirror of claim 1 where the polymer membrane is stretched over a frame that is integrally formed with the second substrate.

5. The active mirror of claim 1 where the second substrate is either silicon or an unpolished printed circuit board material.

6. The active mirror of claim 1 where the polymer membrane is a nitrocellulose pellicle.

7. The active mirror of claim 1 where the optically reflective layer and the conductive layer are the same layer.

8. The active mirror of claim 1 where the membrane is coated with aluminum as both a reflector and a conductive layer.

9. The active mirror of claim 1 where an electrically conductive layer is used to actuate the mirror electrostatically by applying a potential difference between the membrane and a conductive pad on the second substrate.

10. The active mirror of claim 1 where a section of the membrane stiffness is varied spatially such that the mirror deforms into a desired pattern.

11. The active mirror of claim 10 where the membrane stiffness is varied spatially by varying the membrane thickness, bonding a stiffer section to the mirror, or adjusting the material composition of the mirror membrane.

12. An active mirror comprising:
a. a polymer membrane and
b. pillars extending from the polymer membrane to actuators on an underlying substrate.

13. The active mirror of claim 12 where the actuation is provided by bonding actuators to the membrane.

14. The active mirror of claim 12 where the actuation is provided by bonding actuators to pillars that are integrally formed as part of the membrane.

15. The active mirror of claim 12 where the actuators are micromachined.

16. The active mirror of claim 12 where the actuation is provided by any one or any combination of the following: fluidic actuators, electrostatic actuators, thermal actuators, magnetic actuators, piezoelectric actuators, or electrostrictive actuators.

17. The active mirror of claim 12 where a section of the membrane stiffness is varied spatially such that the mirror deforms into a desired pattern.

18. The active mirror of claim 17 where the membrane stiffness is varied spatially by varying the membrane thickness, bonding a stiffer section to the mirror, or adjusting the material composition of the mirror membrane.

19. The active mirror of claim 12 where the pillars connect to a mechanical structure that provides higher stiffness.
